(19) United States
(12) Patent Application Publication
(10) Pub. No.: US 2026/0148750 A1
(43) Pub. Date: May 28, 2026

(54) THERMO-MECHANICAL-OPTICAL BONDING OF LUBRICANTS TO CARBON OVERCOAT OF MAGNETIC RECORDING MEDIA

(71) Applicant: Western Digital Technologies, Inc., San Jose, CA (US)

(72) Inventors: Daniel Demori Maksuta, San Jose, CA (US); Hantao Zhou, San Jose, CA (US); Ao Fan, Shenzhen (CN); Jianming Wen, Pleasanton, CA (US); Charles Cheng-Hsing Lee, San Jose, CA (US)

(21) Appl. No.: 18/956,203

(22) Filed: Nov. 22, 2024

(51) Int. Cl. G11B 5/72; G11B 5/725

(52) U.S. Cl. CPC G11B 5/7266; G11B 5/7257

(57) ABSTRACT

High temperature lubricants for magnetic media include a plurality of segments according to general formula (I):

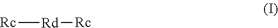

where Rd is any linker chemistry and each Re may be a reactive end-group and anchoring group containing at least one constituent configured for at least one of tribochemical, thermochemical, or optochemical bonding. The at least one constituent can be cyclopropane or cyclobutane.

### FIELD

The disclosure relates to lubricants, and more particularly, to high temperature lubricants, which may be used with media configured for magnetic recording, e.g., for Heat Assisted Magnetic Recording (HAMR) having modified repeat units containing tribochemically active, heat active or light active constituents.

### INTRODUCTION

Magnetic storage systems, such as a hard disk drive (HDD), are utilized in a wide variety of devices in both stationary and mobile computing environments. Examples of devices that incorporate magnetic storage systems include data center storage systems, desktop computers, portable notebook computers, portable hard disk drives, network storage systems, high definition television (HDTV) receivers, vehicle control systems, cellular or mobile telephones, television set top boxes, digital cameras, digital video cameras, video game consoles, and portable media players.

A typical disk drive includes magnetic recording media in the form of one or more flat disks or platters. The disks generally include two main components, namely, a substrate material that gives it structure and rigidity, and a magnetic medium coating that stores the magnetic signals that represent data in a recording layer within the coating. The typical disk drive also includes a read head and a write head, generally in the form of a magnetic transducer which can sense and/or change the magnetic fields stored on the recording layer of the disks. HAMR is a recording technique that can increase the areal density capability (ADC) of written data on a magnetic recording medium having very high coercivity with high-temperature assistance. However, the high recording temperatures applied to the medium may present challenges. Other examples of magnetic recording media include flexible tape media usable for magnetic tape recording.

As a result of the high temperatures associated with HAMR technology, suitable lubricants for use in HAMR media may benefit from high thermal stability arising from better bonding with the COC (carbon overcoat) layer on the media surface. In addition, the higher temperatures also increase the presence of contaminants which may negatively affect data storage. The high temperatures may also cause thermally activated reactions in the lubricant such as decomposition and polymerization which will cause discoloring, i.e., fogging, of the storage medium. It is therefore desirable to find lubricant chemistries that will inhibit these thermally activated reactions while maintaining high evaporation temperature. As such, there is a need in the art for high temperature lubricants having properties suitable for use in HAMR drives, including enhanced bonding of the lubricant to the media and COC in particular.

### SUMMARY

In one aspect, this disclosure provides a lubricant comprising a plurality of segments according to general formula (I):

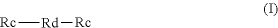

where Rd is a linker and each Rc is a reactive end-group containing at least one constituent configured for at least one of tribochemical, thermochemical, or optochemical bonding.

In one aspect, the lubricant described above wherein the at least one constituent configured for at least one of tribochemical, thermochemical or optochemical bonding is a strained ring.

In one aspect, the lubricant described above wherein the at least one constituent configured for at least one of tribochemical, thermochemical, or optochemical bonding is a ring having a strain energy greater than 10 kilocalories per mole (kcal/mole).

In one aspect, the lubricant described above wherein the at least one constituent configured for at least one of tribochemical, thermochemical, or optochemical bonding is a ring having a strain energy greater than 20 kcal/mole.

In one aspect, the lubricant described above wherein the at least one constituent configured for at least one of tribochemical, thermochemical, or optochemical bonding is selected from the group consisting of cyclopropane, cyclobutane, cyclononane, cycloundecane, norbornene, bicyclo[1.1.0]butane, bicyclo[1.2.0]pentane, bicyclo[1.3.0]hexane, borirane, aziridine, oxirane, phosphirne and thiirane.

In one aspect, the lubricant described above wherein the at least one constituent configured at least one of tribochemical, thermochemical, or optochemical bonding is a C₃-C₁₆ hydrocarbon ring.

In one aspect, the lubricant described above wherein the at least one constituent configured for at least one of tribochemical, thermochemical, or optochemical bonding is cyclopropane or cyclobutane.

In one aspect, the lubricant described above wherein the at least one constituent configured for thermochemical bonding is selected from the group consisting of acetonitrile, propionitrile, acrylonitrile, cyanoacrylate, benzonitrile, butyronitrile, cyanoacetic acid, isobutyronitrile, lactonitrile, methyl isocyanate, propyl isocyanate, butyl isocyanate, toluene diisocyanate, hexamethylene diisocyanate and methylene diphenylmethane diisocyanate.

In one aspect, the lubricant described above wherein Rd includes at least one anchoring functional group comprising at least one of a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, a saturated, unsaturated, aromatic, polycyclic aromatic, heteroaromatic, alicyclic, or heterocyclic C₁-C₅₀ radical.

In one aspect, the lubricant described above wherein Rd includes at least one anchoring functional group comprising —OH.

In one aspect, the lubricant described above wherein Rc includes at least one anchoring functional group comprising at least one of a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, a saturated, unsaturated, aromatic, polycyclic aromatic, heteroaromatic, alicyclic, or heterocyclic C₁-C₅₀ radical.

In one aspect, the lubricant described above wherein Rc includes at least one anchoring functional group comprising —OH.

In one aspect, the lubricant described above wherein the tribochemical, thermochemical or optochemical bonding comprises bonding with a carbon overcoat layer of a magnetic recording medium.

In one aspect, this disclose provides a magnetic recording medium, comprising: a magnetic recording layer on a substrate; a protective overcoat on the magnetic recording layer; and a lubricant layer comprising the lubricant described above on the protective overcoat.

In one aspect, this disclose provides a data storage system, comprising: at least one magnetic head; a magnetic recording medium including the lubricant described above; a drive mechanism for positioning the at least one magnetic head over the magnetic recording medium; and a controller electrically coupled to the at least one magnetic head for controlling operation of the at least one magnetic head.

In one aspect, this disclose provides a method of bonding a lubricant to a carbon overcoat layer (COC) of a magnetic recording medium, including: coating the lubricant described above on the COC; and applying at least one of mechanical action, heat or light to the lubricant to bond the lubricant to the COC.

In one aspect, the method described above further comprising burnishing the magnetic recording medium.

In one aspect, this disclose provides a method of synthesizing the lubricant described

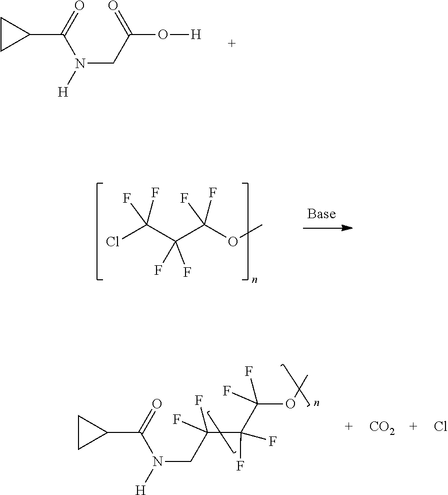

where n=10-200 and the at least one constituent configured for at least one of tribochemical, thermochemical, or optochemical bonding is cyclopropane.

In one aspect, this disclose provides a method of synthesizing the lubricant described above, comprising:

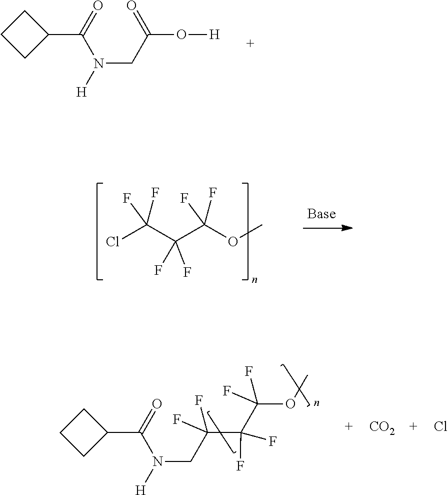

where n=10-200 and the at least one constituent configured for at least one of tribochemical, thermochemical, or optochemical bonding is cyclobutane.

Other aspects and advantages of the present disclosure will become apparent from the following detailed description and examples, when considered in conjunction with the drawings.

### BRIEF DESCRIPTION OF THE DRAWINGS

FIG. 1A is a diagram schematically illustrating a data storage device including a slider and a magnetic recording medium in accordance with one aspect of the disclosure.

FIG. 1B is a side schematic view of the slider and magnetic recording medium of FIG. 1A in accordance with one aspect of the disclosure.

FIG. 2 is a side schematic view of a magnetic medium configured for head assisted magnetic recording in accordance with one aspect of the disclosure.

FIG. 3A is a schematic drawing showing a lubricant including a single main chain segment and a functional group according to one aspect of the disclosure.

FIG. 3B is a schematic drawing showing a lubricant including a single main chain segment and a multitude of functional groups according to one aspect of the disclosure.

FIG. 3C is a schematic drawing showing a lubricant including two chain segments having terminal cyclic functional groups and separated by a linking segment according to one aspect of the disclosure.

FIG. 3D is a schematic drawing showing a lubricant including two chain segments having terminal cyclic functional groups and separated by a linking segment including cyclic functional groups according to one aspect of the disclosure.

FIG. 3E is a schematic drawing showing a lubricant including two chain segments having terminal functional groups and separated by a linking segment according to one aspect of the disclosure.

FIG. 4 shows how a lubricant to COC (Lube-COC) bonding process (square data points) slows the lubricant loss off a disk baked at 250° C. compared to the no process control samples (round data points), in accordance with an aspect of the disclosure.

FIG. 5 shows an exemplary process for applying the lubricant to a disk, in accordance with an aspect of the disclosure.

FIG. 6 is a flowchart of an exemplary process for fabricating a HAMR medium that includes a magnetic recording layer, a capping layer, an overcoat and a lubricant, in accordance with an aspect of the disclosure.

FIG. 7 shows the structures of Z-Tetraol and Z-Tetraol Multidentate (ZTMD).

### DETAILED DESCRIPTION

Heat Assisted Magnetic Recording (HAMR) systems operate at substantially higher temperatures than traditional magnetic recording systems. HAMR is an example of magnetic recording within the class of Energy Assisted Magnetic Recording (EAMR) techniques, where conventional magnetic recording is supplemented by other energy used in the system. Other examples of EAMR may include Microwave Assisted Magnetic Recording (MAMR) and applications of electric current into various conductive and/or magnetic structures near the main pole. This disclosure is generally directed to lubricants having enhanced substrate bonding and high thermal stability that can be used in conjunction with a magnetic recording medium and/or a magnetic data storage system configured for HAMR.

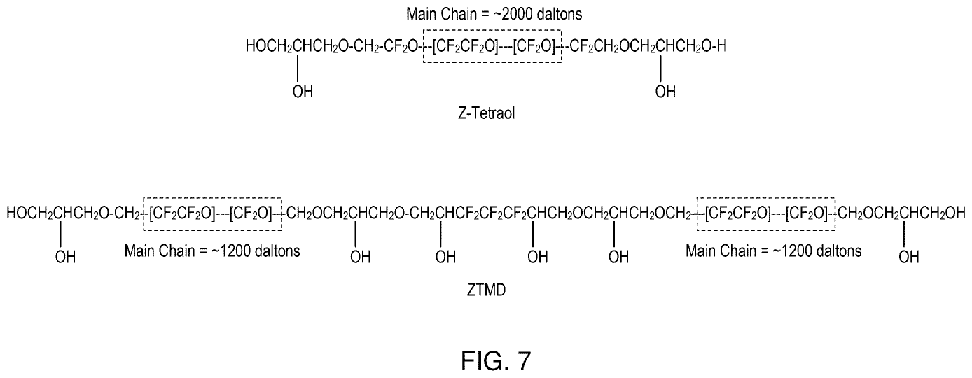

As noted above, conventional lubricants do not provide the high thermal stability needed to adequately support HAMR. FIG. 7 shows the structures of conventional lubricants such as Z-Tetraol or Z-Tetraol Multidentate (ZTMD). Chemicals with tribochemical properties can be mixed, not bonded, with these conventional perfluorinated lubricants to form sacrificial films to protect the COC (carbon overcoat). For example, cyclopropane carboxylic acid or cyclobutane carboxylic acid can be added to the dip coat solution of conventional lubricants such as Z-tetraol or ZTMD to mitigate damage to the COC during HDI (head-disk impact) events. This however, does not reduce the lube loss of the lubricant at elevated temperatures during HAMR recording. This binary solution also complicates the dip coat process and increases the probability of impurities being generated, arising from the extra constituents used in the dip coat mix. Also dosing, the proportion of strained ring carboxylic acid to lubricant, causes additional process steps and an increased probability for errors in the disk manufacturing process.

The present disclosure addresses these problems by incorporating a tribochemical moiety such as a strained ring into the chemical structure of the lubricant itself. The resulting lubricant will be represented by general formula (I):

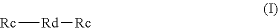

where Rd is any linker chemistry, for example, a short chain repeat unit (CF₂, CH₂O, or R—C—R′) of less than 10 repeat units containing either a reactive end-group with an anchoring group or just an anchoring group, and Rc is an end segment having a reactive end-group and an anchoring group containing at least one constituent configured for tribochemical, thermochemical, or optochemical bonding. This constituent can be, for example, a hydrocarbon ring such as cyclopropane or cyclobutane.

Tribochemical bonding is a surface treatment that uses mechanical collisions or friction to initiate or enhance chemical and physicochemical reactions. Thermochemical bonding is the utilization of heat to initiate a chemical reaction or physical change of state. Optochemical bonding uses light to initiate or control chemical reactions. These bonding methods are characterized by adding energy to initiate or modulate chemical reactions. For example, tribochemical bonding can utilize silica-coated alumina particles to create micromechanical retention and chemically activate the molecule. Ultrasound treatment can also be considered a form of tribochemical bonding. Thermochemical bonding utilizes heat or infrared radiation to activate or modulate a chemical reaction. Optochemical bonding utilizes visible or ultraviolet wavelengths, and different wavelengths can cause different types of reactions. For example, a lower wavelength can produce a cis isomer while a longer wavelength can produce a trans isomer.

In this disclosure, a thermo-mechanical-optical activated bonding functional group may be incorporated into the fluorinated lubricant. In one aspect, tribochemical, thermochemical, or optochemical film forming compounds may be incorporated into the end group of the lubricant. Upon heating, mechanical action or optical agitation, the film forming component will react with the COC to form a covalent bond and thus prevent or substantially mitigate removal of the lubricant. The lubricant can also be expressed as formula (Ia):

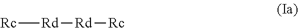

where Rc is an end segment having a reactive end group and an anchoring group which can be, for example, cyclopropane or cyclobutane. The anchoring group can be any normal anchoring group known in the art such as —OH. Each Rd in formula (Ia) may be a linker group, for example, a short chain repeat unit (CF₂, CH₂ and O, or R—C—R′) of less than 10 repeat units containing either a reactive end-group with anchoring group or just an anchoring group.

### Definitions

As used herein, and unless otherwise specified, the term “C.” means hydrocarbon(s) having n carbon atom(s) per molecule, where n is a positive integer. Likewise, a “Cₘ-C_{y}” group or compound refers to a group or compound including carbon atoms at a total number thereof in the range from m to y. Thus, a C₁-C₄ alkyl group refers to an alkyl group that includes carbon atoms at a total number thereof in the range of 1 to 4, e.g., 1, 2, 3 and 4.

“Moiety” refers to one or more covalently bonded atoms which form a part of a molecule. The terms “group,” “radical,” “moiety”, and “substituent” may be used interchangeably.

The terms “hydrocarbyl radical,” “hydrocarbyl group,” or “hydrocarbyl” may be used interchangeably and are defined to mean a group including hydrogen and carbon atoms only. Preferred hydrocarbyls are C₁-C₅₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, cyclononyl, cyclodecyl and the like, aryl groups, such as phenyl, benzyl, naphthyl, and the like.

For purposes herein, a heteroatom is any non-carbon atom, selected from groups 13 through 17 of the periodic table of the elements. In one or more aspects, heteroatoms are non-metallic atoms selected from B, Si, pnictogens (N, P, As, Sb, Bi), chalcogen (O, S, Se, Te), and halogens (F, Cl, Br, I).

Unless otherwise indicated, the term “substituted” means that at least one hydrogen atom has been replaced with at least one non-hydrogen atom or a functional group.

For purposes herein, when a segment includes a particular moiety, it is to be understood that the moiety may be bonded to the respective segment at any substitutable position in which a hydrogen atom may be replaced with a chemical bond between the moiety and the segment.

For purposes herein, a functional group includes one or more of a hydrocarbyl group, a heteroatom, or a heteroatom containing group, such as B, Si, pnictogen, chalcogen, or halogen (such as Br, Cl, F or I), at least one of —OR*, —NR*₂, —NR*—CO—R*, —OR*, *—O—CO—R*, —CO—O—R*, —SeR*, —TeR*, —PR*₂, —PO—(OR*)₂, —O—PO—(OR*)₂, —AsR*₂, —SbR*₂, —SR*, —SO₂—(OR*)₂, —BR*₂, —SiR*₃, —(CH₂)_{q}—SiR*₃, or a combination thereof, wherein q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure, or where at least one heteroatom has been inserted within a hydrocarbyl ring. In an aspect, R* is H such that the functional group may be —OH, —NH₂, —NH—CO—H, —OH, H—O—CO—H, —CO—O—H, —SeH, —TeH, —PH₂, —PO—(OH)₂, —O—PO—(OH)₂, —AsH₂, —SbH₂, —SH, —SO₂—(OH)₂, —BH₂, —SiH₃, —(CH₂)_{q}—SiH₃, or a combination thereof.

In one or more aspects, functional groups may include: a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, pnictogen, chalcogen, halogen, saturated, unsaturated, aromatic, polycyclic aromatic, heteroaromatic, alicyclic, and/or heterocyclic C₄-C₅₀ radical. Anchoring functional groups can also be least one of —OH, —NH₂, —NH—CO—H, —O—CO—H, —CO—O—H, —SeH, —TeH, —PH₂, —PO—(OH)₂, —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

For purposes herein, a cyclic functional group is a monovalent alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. Unless otherwise indicated, the cyclic functional group may be further substituted with another cyclic functional group and/or with one or more functional groups including one or more of a saturated C₁-C₅₀ radical, an unsaturated C₁-C₅₀ radical, an alicyclic C₃-C₅₀ radical, a heterocyclic C₃-C₅₀ radical, an aromatic C₅-C₅₀ radical, a heteroaromatic C₅-C₅₀ radical, a cyclotriphosphazine radical, a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, where q is 1 to 10 and each R* is, independently a hydrogen, a pnictogen/chalcogen/halogen, or a saturated, unsaturated, aromatic, polycyclic aromatic, heteroaromatic, alicyclic, or heterocyclic C₁-C₅₀ radical.

For purposes as described herein, an anchoring functional group which is selected for being attachable to and/or engageable with a protective overcoat of a magnetic recording medium refers to a functional group having increased affinity for the protective overcoat of the magnetic recording medium relative to the affinity of a fluoroalkenyl ether moiety, a perfluoroalkyl ether moiety, a perfluoroalkenyl ether moieties, to that same surface. Increased affinity may include Van der Waals forces, weak London Dispersion forces (temporary dipoles), dipole-dipole forces, polar interactions, polarizability/hydrogen bonding interactions, and/or the like, and/or may include the formation of one or more types of bonds, backbonding (electron density is donated from a filled orbital on one atom to an empty orbital on an adjacent atom), and/or dative bonds (where both electrons in the shared pair come from only one of the participating atoms) with the protective overcoat of a magnetic recording medium. In one or more aspects, a functional group which is attachable to and/or engageable with a protective overcoat of a magnetic recording medium refers to one or more functional groups having increased affinity for the carbon overcoat (COC) layer of the magnetic recording medium, relative to the affinity of a fluoroalkenyl ether moiety, a perfluoroalkyl ether moiety, a perfluoroalkenyl ether moieties to that same surface. In some aspects, functional groups attachable to and/or engageable with a protective overcoat of a magnetic recording medium include radicals including one or more hydroxyl moieties (—OH), or a single hydroxyl moiety (—OH).

A “heterocyclic ring,” also referred to herein as a heterocyclic radical, is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring is a heterocyclic ring where a hydrogen of one of the ring atoms is substituted, i.e., replaced, with a hydrocarbyl, or a heteroatom containing group.

A “compound” refers to a substance formed by the chemical bonding of a plurality of chemical elements. A “derivative” refers to a compound in which one or more of the atoms or functional groups of a precursor compound have been replaced by another atom or functional group, generally by means of a chemical reaction having one or more steps.

Fluorinated alkyl ethers including fluoroalkyl ethers, fluoroalkenyl ethers, perfluoroalkyl ethers, perfluoroalkenyl ethers, or combinations thereof, refer to branched or linear chains of C₁ to C₂₀ alkyl ethers in which one or more hydrogen atoms are substituted with fluorine. In one aspect, all or a majority of alkyl hydrogen atoms are substituted with fluorine.

For any particular compound disclosed herein, any general or specific structure presented also encompasses all conformational isomers, regio-isomers, and stereoisomers that may arise from a particular set of substituents, unless stated otherwise. Similarly, unless stated otherwise, the general or specific structure also encompasses all enantiomers, diastereomers, and other optical isomers whether in enantiomeric or racemic forms, as well as mixtures of stereoisomers, as would be recognized by a skilled artisan.

As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

As used herein, a moiety which is chemically identical to another moiety is defined as being identical in overall composition exclusive of isotopic abundance and/or distribution, and/or exclusive of stereochemical arrangement such as optical isomers, confirmational isomers, spatial isomers, and/or the like.

### HAMR System for Employing Lubricant

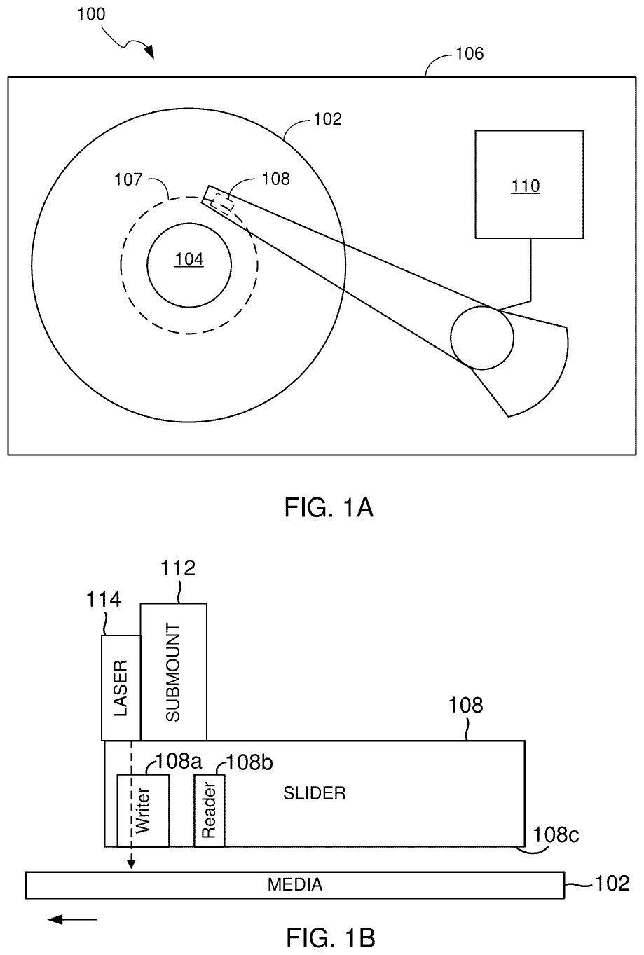

FIG. 1A is a top schematic view of a data storage device 100 (e.g., disk drive or magnetic recording device) configured for heat assisted magnetic recording (HAMR) including a slider 108 and a magnetic recording medium 102 having a lubricant according to one or more aspects of the disclosure. The laser (not visible in FIG. 1A, but see 114 in FIG. 1B) is positioned with a head/slider 108. Disk drive 100 may include one or more disks/media 102 to store data. Disk/media 102 resides on a spindle assembly 104 that is mounted to a drive housing 106. Data may be stored along tracks in the magnetic recording layer of disk 102. The reading and writing of data is accomplished with the head 108 (slider) that may have both read and write elements (108a and 108b). The write element 108a is used to alter the properties of the magnetic recording layer of disk 102 and thereby write information thereto. In one aspect, head 108 may have magneto-resistive (MR), giant magneto-resistive (GMR), or tunnel magneto-resistive (TMR) elements. In an alternative aspect, head 108 may be another type of head, for example, a Hall effect head. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). It is noted that while an example HAMR system is shown, the various embodiments described may be used in other EAMR or non-EAMR magnetic data recording systems, including perpendicular magnetic recording (PMR) disk drives or magnetic tape drives.

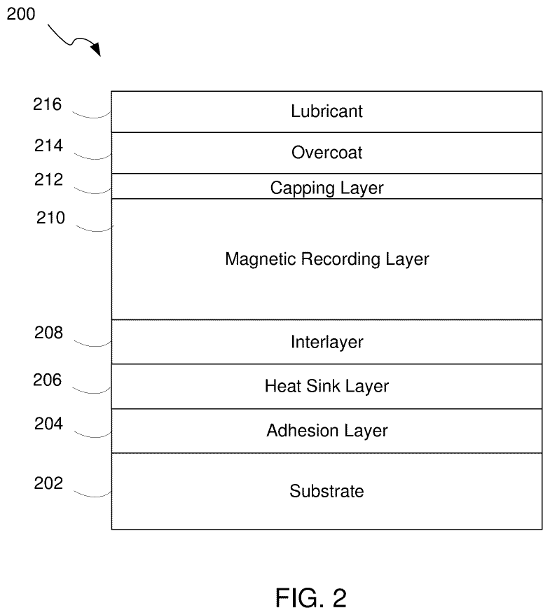

FIG. 1B is a side schematic view of the slider 108 and magnetic recording medium 102 of FIG. 1A. The magnetic recording medium 102 includes a lubricant layer (see FIG. 2) in accordance with one or more aspects of the disclosure. The slider 108 may include a sub-mount 112 attached to a top surface of the slider 108. The laser 114 may be attached to the sub-mount 112, and possibly to the slider 108. The slider 108 includes a write element (e.g., writer) 108a and a read element (e.g., reader) 108b positioned along an air bearing surface (ABS) 108c of the slider for writing information to, and reading information from, respectively, the medium 102. In other aspects, the slider may also include a layer of the lubricant (not shown).

In operation, the laser 114 is configured to generate and direct light energy to a waveguide (possibly along the dashed line) in the slider which directs the light to a near field transducer (NFT) near the air bearing surface (e.g., bottom surface) 108c of the slider 108. Upon receiving the light from the laser 114 via the waveguide, the NFT generates localized heat energy that heats a portion of the medium 102 near the write element 108a and the read element 108b. The anticipated recording temperature is in the range of about 350° C. to 400° C. In the aspect illustrated in FIG. 1B, the laser directed light is disposed between the writer 108a and a trailing edge of the slider. In other aspects, the laser directed light may instead be positioned between the writer 108a and the reader 108b. FIGS. 1A and 1B illustrate a specific aspect of a HAMR system. In other aspects, the magnetic recording medium 102 with the lubricant layer according to aspects of the disclosure can be used in other suitable HAMR systems (e.g., with other sliders configured for HAMR).

FIG. 2 is a side schematic view of a magnetic recording medium 200 having a lubricant layer according to one or more aspects of the disclosure. In one aspect, the magnetic recording medium 200 may be used in a HAMR system (e.g., disk drive 100). The magnetic recording medium 200 has a stacked structure with a substrate 202 at a bottom/base layer, an adhesion layer 204 on the substrate 202, a heat sink layer 206 on the adhesion layer 204, an interlayer 208 on the heat sink layer 206, a magnetic recording layer (MRL) 210 on the interlayer 208, a capping layer 212 on the MRL 210, an overcoat layer (e.g., carbon overcoat layer or COC layer) 214 on the capping layer 212, and a lubricant layer 216 on the overcoat layer 214. In one aspect, the magnetic recording medium 200 may have a soft magnetic underlayer (SUL) between the adhesion layer 204 and the heat sink layer 206. In one aspect, the magnetic recording medium 200 may have a thermal resistance layer (TRL) between the interlayer 208 and the heat sink layer 206. In one aspect, for disk drive applications, the substrate 202 can be made of one or more materials such as an Al alloy, NiP plated Al, glass, glass ceramic, and/or combinations thereof. In one aspect for magnetic tape recording applications, the substrate 202 can include a flexible material, such a film made of one of various types of resins, polyesters, polyolefins, polyamides, and the like, or combinations thereof. The substrate may include non-magnetic materials, and may be laminated. In some aspects, the magnetic recording medium 200 may have some or all of the layers illustrated in FIG. 2 and/or additional layer(s) in various stacking orders. It should also be noted that each layer shown in FIG. 2 may include one or more sub-layers. For example, the magnetic recording layer may be formed from multiple layers in certain embodiments. Also, some of the layers may be etched before the next layer is applied.

Lubricants according to aspects disclosed herein may function as boundary lubricants which may be used in various mechanical devices, including on the magnetic recording media of hard disk drives or tape drives and in conjunction with other microelectronic mechanical systems. Boundary lubricants may form a lubricant layer when one or more functional groups of the lubricant attach or otherwise engage with the surface being lubricated. For instance, one or more boundary lubricants may form the lubricant layer 216 on magnetic recording medium 200 (e.g., a disk that includes a magnetic recording layer 210) that moves relative to other parts in the magnetic storage device. This lubricant layer 216 may help to protect the magnetic recording medium from friction, wear, contaminations, smearing, and/or damage caused by interactions between the magnetic recording medium and other parts in the storage device (e.g., interactions between a slider and the magnetic recording medium). In other words, this boundary layer may help limit solid-to-solid contact.

While the HDD examples illustrated in FIGS. 1A, 1B, and 2 primarily relate to HAMR technology that involves the use of lubricants, the lubricants described herein may also be used in other magnetic recording technologies. These may include Microwave Assisted Magnetic Recording (MAMR), Perpendicular Magnetic Recording (PMR), Enterprise Perpendicular Magnetic Recording (ePMR), Shingled Magnetic Recording (SMR), or any other magnetic recording technology employing lubricants on magnetic media (e.g., magnetic recording disks or magnetic recording tape).

### Lubricant Characteristics

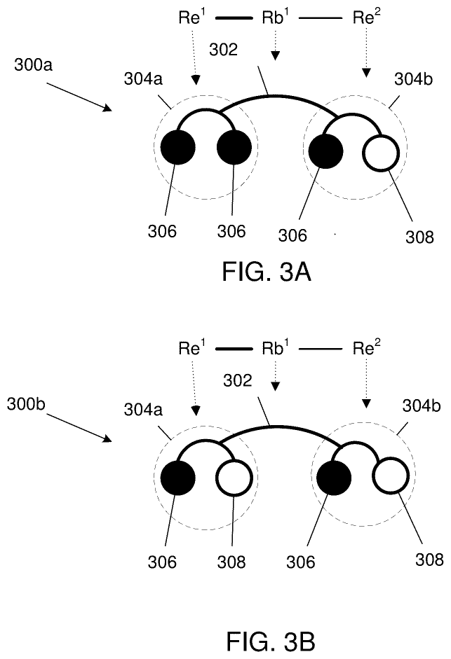

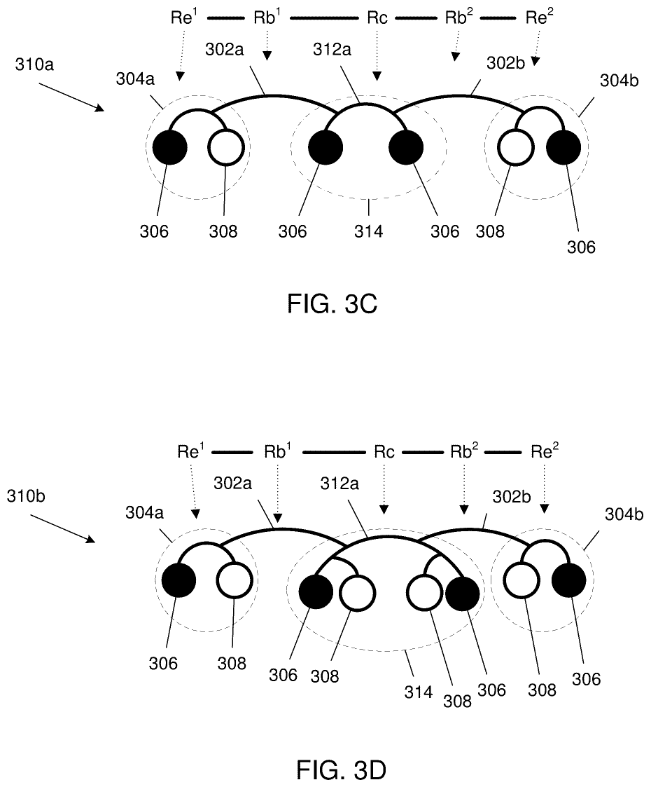

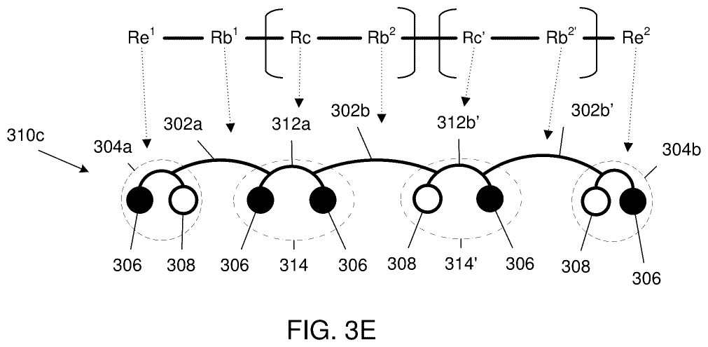

FIGS. 3A-3D illustrate boundary lubricants according to aspects of the disclosure. FIG. 3A is a schematic drawing showing a lubricant including a single main chain segment and a functional group according to one aspect of the disclosure. In one aspect as shown in FIG. 3A, the boundary lubricant generally referred to as 300a may have general formula (II):

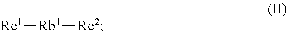

wherein Rbⁱ(302) is a chain segment having a repeating unit having an optimized dipole moment that can be, for example, a fluoroalkyl, fluoroalkenyl, perfluoroalkyl, or perfluoroalkyl ether moiety bonded on either side to an end segment 304a and 304b. In the aspect shown in FIG. 3A, the chain segment Rbⁱ(302) may be also be referred to as a main chain segment. Each of Re¹ (304a) and Re² (304b) are end segments which independently includes an anchoring functional group 306 selected for being attachable to and/or engageable with a protective overcoat of a magnetic recording medium (see FIG. 2). In the aspect shown, one or more of the end segments Re¹ (304a) and Re² (304b) includes a group that has a higher rotational energy barrier than CH₂, which can be for example benzene, toluene, anisole, other aromatic groups, (CF₂)ₙ where n=1-10, etc.

FIG. 3B is a schematic drawing showing a lubricant including a single main chain segment and a multitude of functional groups according to one aspect of the disclosure. As shown in FIG. 3B, in one aspect indicated as 300b, each end group segment may include a cyclic or aromatic functional group 308. In FIG. 3A, end group segment 304a includes two anchoring functional groups 306. In FIG. 3B, end group segment 304a includes one anchoring functional group 306 and one cyclic or aromatic functional group 308.

FIG. 3C is a schematic drawing showing a lubricant including two chain segments having terminal cyclic functional groups and separated by a linking segment according to one aspect of the disclosure. In one aspect as shown in FIG. 3C, the boundary lubricant generally referred to as 310a may have general formula (III):

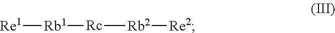

where the end segments Re¹ (304a) and Re² (304b) are as described above; in this aspect there are two chain segments Rbⁱ(302a) and Rb² (302b), which may also be referred to herein as sidechain segments, both of which has a repeating group with an optimized dipole moment, which may independently be, for example, a fluoroalkyl, fluoroalkenyl, perfluoroalkyl, or perfluoroalkyl ether moiety.

As is indicated in FIG. 3C, whether referred to as a chain segment, a main chain segment (when only one is present), or a sidechain segment (when two or more are present), each of the segments are similar to one another in that segments may have an optimized dipole moment, and may include, for example, a fluoroalkyl, fluoroalkenyl, perfluoroalkyl, or perfluoroalkyl ether moiety.

In the aspect shown in FIG. 3C, the lubricant may further include a divalent linking segment Rc (312a), generally indicated as 314, also referred to herein as a center segment, which is disposed between either end of the sidechain segments 302a and 302b, and which includes at least one anchoring functional group (306) as defined herein.

FIG. 3D is a schematic drawing showing a lubricant including two chain segments having terminal cyclic functional groups and separated by a linking segment including cyclic functional groups according to one aspect of the disclosure. As shown in FIG. 3D, in one aspect generally indicated as 310b, the divalent linking segment Rc (312a) may further include at least one cyclic functional group 308 as defined herein.

FIG. 3E is a schematic drawing showing a lubricant including two chain segments having terminal functional groups and separated by a linking segment according to one aspect of the disclosure. In one aspect as shown in FIG. 3E, the boundary lubricant generally referred to as 310c may have general formula (IV):

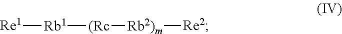

wherein m=2, including two units of the divalent linking segments; a first unit including Rc (312a) also generally indicated as (314), attached to a chain segment with an optimized dipole moment Rb² (302b), which is attached to a second unit including Rc′ (312b′) also generally indicated as (314′) and a second chain segment Rb²′ (302b′). The end segments Re¹ (304a) and Re² (304b) are attached to either end of the molecule. The composition of each of the segments may be independent of one another.

In one aspect, each anchoring functional group may independently be a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, or a saturated, unsaturated, aromatic, polycyclic aromatic, heteroaromatic, alicyclic, and/or heterocyclic C₁-C₅₀ radical, and two or more R* may join together to form a ring structure. When R* is H, the anchoring functional group can be OH, —NH₂, —NH—CO—H, —OH, —O—CO—H, —CO—O—H, —SeH, —TeH, —PH₂, —PO—(OH)₂, —O—PO—(OH)₂, —N═P(NH₂)₃, —AsH₂, —SH, —SO₂—(OH)₂, —BH₂, —SiH₃, —(CH₂)_{q}—SiH₃, —(CF₂)_{q}—SiH₃, or a combination thereof.

In one aspect, each cyclic functional group may further be, e.g., may be further substituted with a functional group including at least one of a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, a saturated, unsaturated, aromatic, polycyclic aromatic, heteroaromatic, alicyclic, and/or heterocyclic C₁-C₅₀ radical, and two or more R* may join together to form a ring structure.

In one aspect, one or more anchoring functional group may include, or is, a hydroxyl (—OH) moiety. In one aspect, each anchoring functional group includes or is a hydroxyl (—OH) moiety. In some aspects, one or more cyclic functional groups may be a hydroxyl (—OH) moiety. In some aspects, each cyclic functional group is a hydroxyl (—OH) moiety.

### Molecular Design

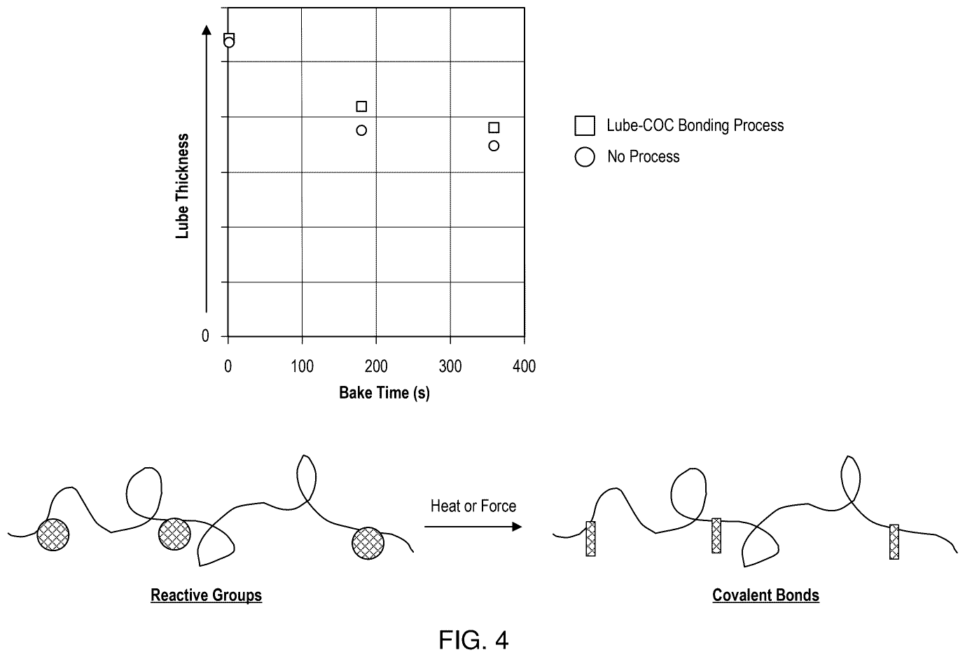

The molecular design of lubricants described herein was performed in light of current high temperature lubricants for HDD which rely upon increasing molecular stiffness to reduce lubricant loss. However, another method of reducing lube loss involves increasing the interaction energy of the lubricant with the disk surface as shown in the FIG. 4.

FIG. 4 shows how a lubricant to COC (Lube-COC) bonding process (square data points) slows the lube loss off a disk baked at 250° C. compared to the no process control samples (round data points), i.e., lubricant by itself that has not been bonded. In the lower part of FIG. 4, heat or force transform the reacted groups (indicated by circles) into covalent bonds (indicated by rectangles). This bonding process however is non-selective and just randomly bonds the lube to the disk at uncontrolled points in the molecule. By designing a lubricant molecule with specific sites to covalently bond to the disk, the lubricants of the disclosure can better control lubrication potential of each molecule rather than have each molecule randomly bonded. The disclosure thus can utilize a specific functional group and process to bond the lubricant to the COC.

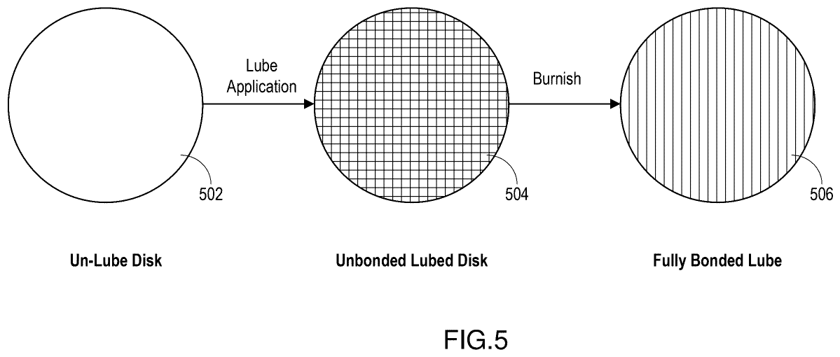

FIG. 5 shows the process of applying the lubricant to a disk (e.g., magnetic recording medium in disk form), in accordance with an aspect of the disclosure. Lubricant is applied to the un-lubricated disk 502 to produce an unbonded lubricated disk 504. A subsequent heat treatment and/or burnishing process (discussed below) yields a fully bonded disk 506.

In some aspects, the present disclosure incorporates a tribochemical, thermochemical, or optochemical moiety (such as a strained ring), a heat sensitive moiety or a light sensitive moiety into the chemical structure of the lubricant itself. The resulting lubricant will be represented by general formula (I):

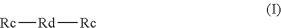

where Rd is any linker chemistry and each Rc is an end segment having a reactive end-group and anchoring group containing at least one constituent configured for tribochemical bonding.

In the disclosure, a thermo-mechanical-optical activated bonding functional group may be incorporated into the fluorinated lubricant. In one aspect, tribochemical, thermochemical, or optochemical film forming compounds may be incorporated into the end group of the lubricant. Upon heating, mechanical action or optical agitation, the tribochemical, thermochemical, or optochemical film forming component can react with the COC to form a covalent bond and thus prevent or mitigate removal of the lubricant. The lubricant can also be expressed as formula (Ia):

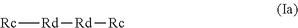

where Rc is an end segment having a reactive end group and anchoring group which can be, for example, cyclopropane or cyclobutane. The anchoring group can be any normal anchoring group known in the art such as —OH. Rd is a short chain repeat unit (CF₂, CH₂O, or R—C—R′) of less than 10 repeat units containing either: at least one reactive end-group with an anchoring group, or just at least one anchoring group.

In the above formulas Rd is a chain segment having a repeating unit that can be, for example, a fluoroalkyl, fluoroalkenyl, perfluoroalkyl, or perfluoroalkyl ether moiety.

Since the lubricant will become less mobile after reacting with the COC, utilization of a more flexible and long main-chain will off-set this reduced mobility. The number of reactive end-groups will influence the probability of the molecule being covalently anchored to the carbon. Utilizing a reactive group in the center will therefore further increase the probability of reaction, however, it may reduce the lubricating potential of the molecule more than just having the end-group only. Re may be, for example, a fluorinated hydrocarbon or polyether containing the reactive end group and anchoring group.

The end group can include an anchoring functional group and a tribochemical group such as cyclopropane or cyclobutane. However, any group that has a large ring strain can mechanically, thermally or optically decompose and serve as the reactive group. Generally, cyclopropane and cyclobutane are the thermo-mechanical-optically active groups that form the covalent bond with the COC surface. For thermally active groups, nitrile or isocyanate containing molecules can be used. The anchoring functional group acts to improve processability and bring the reactive end-group close to the COC surface to ensure it bonds with the COC upon activation.

The effectiveness of cycloalkanes in the lubricant of the disclosure can be seen in the strain energies tabulated in Table 1.

TABLE 1
Strain of Some Common Cycloalkane Ring Sizes.

| Ring | Strain Energy |
|---|---|
| Size | (kcal/mole) |
| 3 | 27.5 |
| 4 | 26.3 |
| 5 | 6.2 |
| 6 | 0.1 |
| 7 | 6.2 |
| 8 | 9.7 |
| 9 | 12.6 |
| 10 | 12.4 |
| 11 | 11.3 |
| 12 | 4.1 |
| 13 | 5.2 |
| 14 | 1.9 |
| 15 | 1.9 |
| 16 | 2.0 |

The highest strain energies are observed for the C₃ and C₄ rings (cyclopropane and cyclobutane), which are greater than 25 (kilocalories per mole or kcal/mole). In cyclopropane, the C—C—C bond angles are 60° whereas tetrahedral 109.5° bond angles are expected. The intense angle strain leads to nonlinear orbital overlap of its sp³ orbitals. Because of the bond's instability, cyclopropane is more reactive than other alkanes. Since any three points make a plane and cyclopropane has only three carbons, cyclopropane is planar. The H—C—H bond angle is 115° whereas 106° is expected as in the CH₂ groups of propane. In cyclobutane, if the cyclobutane were completely square planar, its bond angles would be 90° whereas tetrahedral 109.5° bond angles are expected. However, the actual C—C—C bond angle is 88° because it has a slightly folded form to relieve some torsional strain at the expense of slightly more angle strain. The high strain energy of cyclobutane is primarily from angle strain.

However, elevated strain energies can also be seen for the C₉ through C₁₁ rings (cyclononane, cyclodecane and cycloundecane), having strain energies greater than 10. More complicated hydrocarbon ring structures can also be utilized, such as norbornene, bicyclo[1.1.0]butane, bicyclo[1.2.0]pentane, and bicyclo[1.3.0]hexane, which are shown in Table 2.

TABLE 2
Bicyclic Hydrocarbon Rings

| | |
|---|---|
| 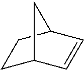 | 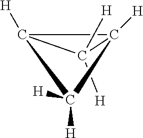 |
| Norbornene | Bicyclo[1.1.0]butane |
| 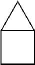 | 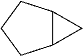 |
| Bicyclo[1.2.0]pentane | Bicyclo[3.1.0]hexane |

Strained ring structures can contain heteroatoms such as B, N, O, P and S. Three member rings with one heteroatom include borirane, aziridine, oxirane, phosphirne and thiirane. Three member rings with two heteroatoms include diaziridine, oxaziridine and dioxirane. Four member rings with one heteroatom include azetidine, oxetane, phosphetane and thietane. Four memer rings with two heteroatoms include dizetine, dioxetane and dihetane. The structure of a selection of these heteroatom compounds is set forth in Table 3.

TABLE 3
Structure of Heteroatom Compounds.

| | |
|---|---|
| 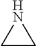 | 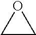 |
| Aziridine | Oxirane |
| 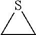 | 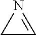 |
| Thirane | Azirine |
| 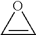 | 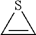 |
| Oxirene | Thiirene |
| 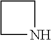 | 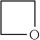 |
| Azetidene | Oxetane |
| 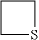 | 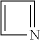 |
| Thietane | Azete |
| 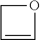 | 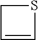 |
| Oxete | Thiete |

Five member rings containing heteroatoms such as O, N, P or S, which can have sufficient strain, can also be utilized. This compounds include pyrrole, pyrrolidine, furan, tetrahydrofuran, phosphole, phospholane, thiophene, tetrahydrothiophene, imidazole, imidazolidine, pyrazole, pyrazolidine, oxathiole, 1,3-oxathiolane, Isoxathiole, 1,2-oxathiolane, oxazole, oxazolidine, isooxizole, isoxazolidine, thiozole, thiazolidine, isothiozole, isothiazolidine, diozolane, dithiole, and dithiolane. Five membered rings having at least three heteroatoms include triazole, furazan, oxadiazole, thiadiazole, dixazole, dithiazole, tetrazole, qxatetrazole, thiatetrazole and pentazole. Structures of some of the five member ring compounds can be found in Table 4.

TABLE 4
Five Member Ring Structures.

| | |
|---|---|
| 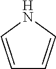 | 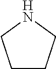 |
| Pyrrole | Pyrrolidine |
| 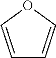 | 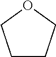 |
| Furan | Tetrahydrofuran |
| 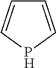 | 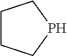 |
| Phosphole | Phospholane |
| 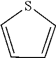 | 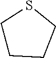 |
| Thiophene | Tetrahydrothiophene |
| 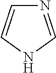 | 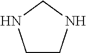 |
| Imidazole | Imidazolidine |
| 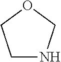 | 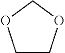 |
| Oxazolidine | Dioxolane |

For thermally active groups, nitrile or isocyanate containing molecules can be used. The nitriles have a —C≡N functional group. The nitriles include acetonitrile, propionitrile, acrylonitrile, cyanoacrylate, benzonitrile, butyronitrile, cyanoacetic acid, isobutyronitrile, and lactonitrile. The isocyanates have a —R—N═C═O structure. The isocyanates include methyl isocyanate, propyl isocyanate, butyl isocyanate, toluene diisocyanate (TDI), hexamethylene diisocyanate (HDI) and methylene diphenylmethane diisocyanate (MDI).

Moieties that can be light activated include acrylates, methacrylates, o-nitribenzyl.

The anchoring functional groups discussed above act to improve processability and bring the reactive end-group close to the COC surface to ensure it bonds with the COC upon activation. In tribofilm formation, increasing the number of anchoring groups increases the residence time of the molecule on the surface which facilitates the dissociation induced either mechanically or thermally.

### Synthesis Example 1

The synthesis route attaches the reactive end group and anchoring group to the main-chain unit of the lubricant. A typical synthesis to synthesize a lubricant of formula (V) is below:

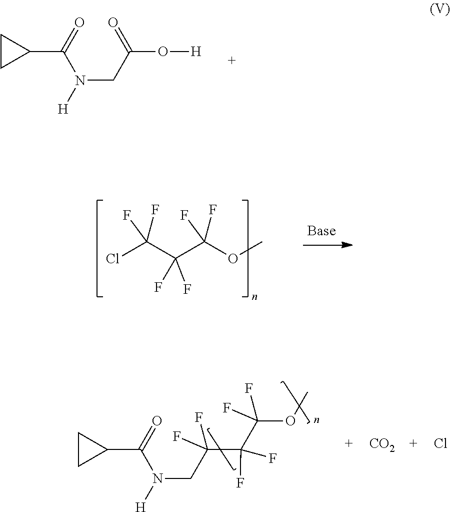

where n=10-200. The cyclopropane is thermally unstable at temperatures greater than ˜200° C. and under mechanical stress. This should prevent the reaction of the reactive group except when data is being written or the media is in contact with the head.

A similar synthesis using a cyclobutane end group can be used to produce formula (VI):

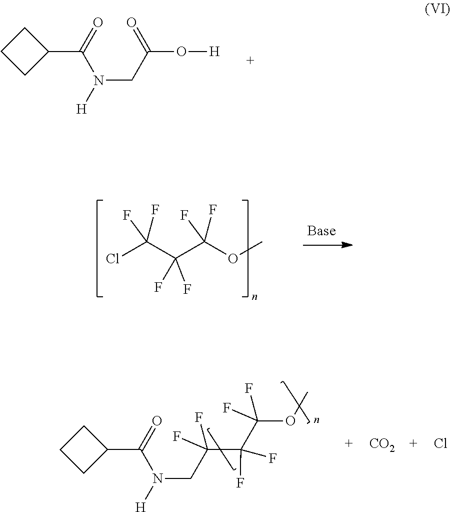

where n=10-200.

Other synthetic pathways can entail the utilization of click chemistry, which not only can be used to attach cyclopropyl or cyclobutyl rings but the other rings disclosed above as well. For example, CuAAC (Copper(I)-catalyzed Azide-Alkyne Cycloaddition) chemistry or SuFEx (sulfur-fluoride exchange) chemistry can be used.

The process implementation is illustrated in FIG. 5. The disk 502 is coated with lubricant to yield a disk 504 coated with non-bonded lubricant. By using a burnish process, a thermal annealing or activation process, an optical exposure process or some other process to both bond and remove particles, a disk coated with fully bonded lubricant 506 is produced. The throughput, i.e., the product yield, is not impacted by additional processes to bond the lube, like the utilization of UV or thermal treatment.

Based on experimental results for CPCa (cyclopropane carboxylic acid—a cyclopropane containing small molecule) the burnish process should apply more than enough force to activate the bonding mechanism for the proposed molecule.

### Divalent Linking Segment (Rd)

In one aspect, a lubricant may have general formulas general formulas (I) or (Ia):

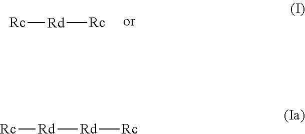

where each Rd may be any linker chemistry and Rc is a reactive end-group and anchoring group containing at least one constituent configured for tribochemical bonding.

In one aspect, Rd includes or has general formula (VIII):

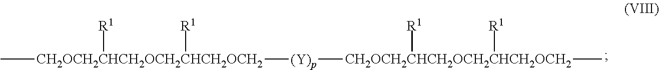

wherein each Y independently includes:

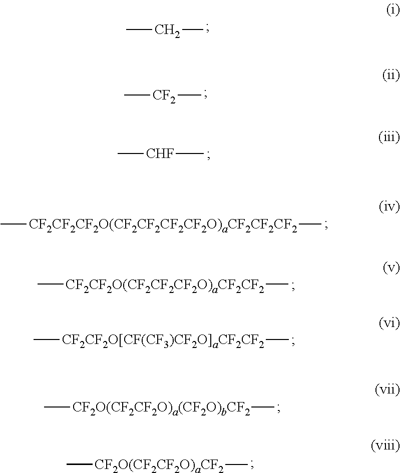

or a combination thereof;

wherein each a is, independently from 1 to 20,

wherein each b, when present, is independently from 1 to 20;

wherein p is from 1 to 20; and

wherein at least one R¹ is an anchoring functional group engageable with a protective overcoat of a magnetic recording medium, formed from B, Si, a pnictogen, a chalcogen, a halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, a heterocyclic C₂-C₅₀ radical, and wherein two or more R* may join together to form a ring structure.

In a related aspect, at least one R¹ present on the linking segment Re may optionally be a cyclic functional group including an alicyclic C₃-C₅₀ alkyl radical, an alicyclic C₃-C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. In one aspect, at least one R¹ present on the linking segment Re may be a hydroxyl moiety (—OH). In another aspect, each R¹ present on the linking segment Re may be a hydroxyl moiety, e.g., is a hydroxyl moiety or is substituted with a hydroxyl moiety. In another aspect, each R¹ present on the linking segment Rc is a hydroxyl moiety.

In an aspect, Rc includes or is of general formula (IX):

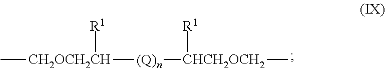

where each Q independently may be:

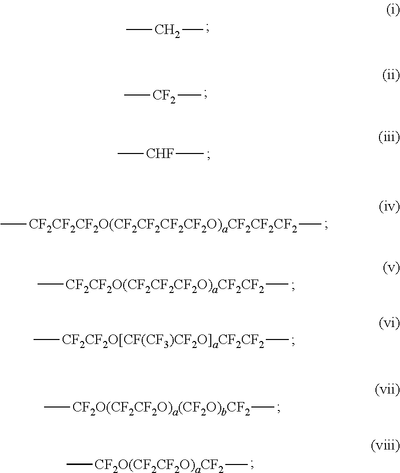

or a combination thereof;

wherein each a is, independently from 1 to 20, or from 1 to 10, or from 1 to 5;

wherein each b, when present, is independently from 1 to 20 or from 1 to 10, or from 1 to 5; wherein n is from 1 to 20 or from 1 to 10, or from 1 to 5; and

wherein at least one R¹, when present, is an anchoring functional group engageable with a protective overcoat of a magnetic recording medium, including B, Si, a pnictogen, a chalcogen, a halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently, a hydrogen, B, Si, a pnictogen, a chalcogen, a halogen, a saturated C₁-C₅₀ radical, an unsaturated C₂-C₅₀ radical, an aromatic C₄-C₅₀ radical, a polycyclic aromatic C₅-C₅₀ radical, a heteroaromatic C₅-C₅₀ radical, an alicyclic C₃-C₅₀ radical, a heterocyclic C₂-C₅₀ radical, wherein two or more R* may join together to form a ring structure.

In a related aspect, at least one R¹, when optionally present on the linking segment Rc, may be a cyclic functional group including an alicyclic C₃-C₅₀ alkyl radical, an alicyclic C₃—C₅₀ alkenyl radical, a heterocyclic C₃-C₅₀ radical, an aromatic C₅-C₅₀ radical, a polycyclic aromatic C₁₀-C₅₀ radical, a heteroaromatic C₅-C₅₀ radical, a cyclotriphosphazine radical, or a combination thereof. In one aspect, at least one R¹ present on the linking segment Re may be a hydroxyl moiety (—OH). In another aspect, each R¹, if present on the linking segment Rc, is a hydroxyl moiety or is substituted with a hydroxyl moiety. In another aspect, each R¹ present on the linking segment Rc is a hydroxyl moiety.

In one aspect, Re may be an ester functional group according to general formula (X), general formula (XI), or a combination thereof:

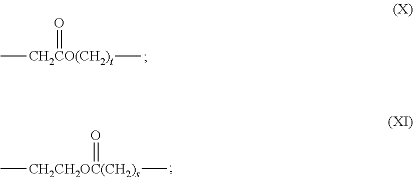

where t, when present, is from 1 to 20, or from 1 to 10, or from 1 to 5; and

wherein s, when present, is from 1 to 20, or from 1 to 10, or from 1 to 5.

The lubricants of the disclosure are not restricted to having a divalent linking segment. Multivalent linking segments can also be utilized. For example a benzyl or cyclohexyl linking segment can have up to 6 “arms” to yield a starfish geometry of the lubricant molecule.

In one or more aspects, the lubricants are stable above about 250° C., or above about 300° C., or above about 325° C., or above about 350° C., or above about 375° C., and less than or equal to about 450° C., or 425° C. when determined in air, nitrogen, helium, or 90 vol % helium 10 vol % oxygen.

In one or more aspects, the lubricant has a weight average molecular weight of greater than or equal to about 0.5 kiloDalton (kDa), or from about 1 to about 20 kDa, or from about 2 to about 10 kDa, or from about 3 to about 7 kDa, or from about 1 to about 5 kDa, or 2 to about 4 kDa.

In one or more aspects, the lubricant has a weight average molecular weight of greater than or equal to about 500 grams per mole (g/mol), or from about 1,000 to about 20,000 g/mol, or from about 2,000 to about 10,000 g/mol, or from about 3,000 to about 7,000 g/mol, or from about 1,000 to about 5,000 g/mol, or 2,000 to about 4,000 g/mol.

In one or more aspects, the lubricants are essentially pure compounds, having a polydispersity, defined as the number average molecular weight Mn divided by the weight average molecular weight Mw (Mn/Mw), from about 1 to 2, or from about 1 to about 1.5, or from about 1 to about 1.1, or from about 1 to about 1.05.

Returning to FIG. 2, in one or more aspects, the magnetic recording medium 200 has a stacked structure which includes a lubricant layer 216 according to the disclosure on the overcoat layer 214.

In one or more aspects, the average thickness of the lubricant layer of the magnetic recording medium is less than about 10 nanometers (nm), or less than about 5 nm, or less than or equal to about 1 nm. In some aspects, the lubricant of the magnetic recording medium has an average thickness from about 0.1 nm to about 10 nm, or from about 0.1 nm to about 1 nm.

In one or more aspects of the magnetic recording medium, the lubricant may have a bonding percentage of at least about 30%, or at least about 50%, or at least about 70%, or at least about 80%, or at least about 90%, and less than or equal to about 99%, or less than or equal to about 95%, corresponding to a post-stripping bonding level of the lubricant to the total area of an upper surface of the protective overcoat.

In one aspect, a magnetic data storage system may include a magnetic head; a magnetic recording medium according to any one or a combination of aspects disclosed herein including a lubricant according to one or more aspects disclosed herein, a drive mechanism for moving the magnetic head over the magnetic recording medium; and a controller electrically coupled to the magnetic head for controlling operation of the magnetic head.

### Media Fabrication

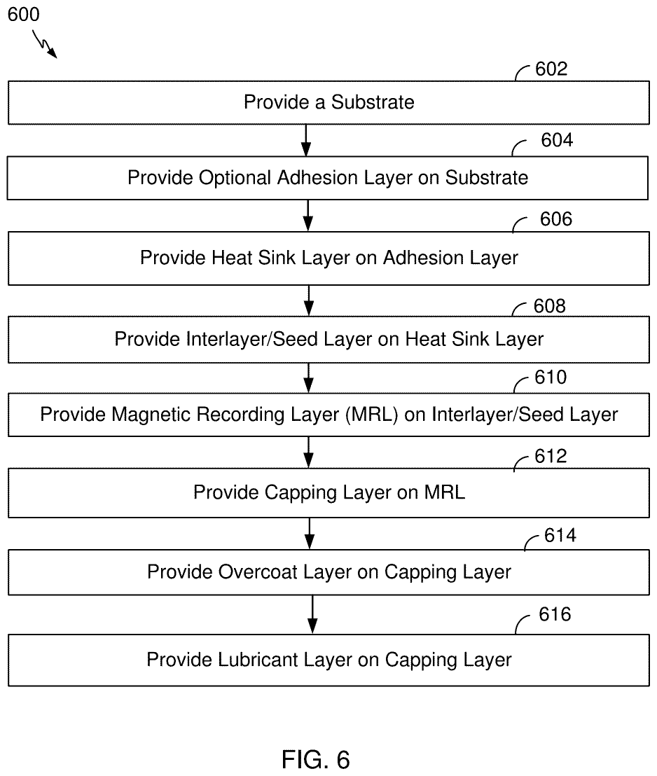

FIG. 6 is a flowchart of an exemplary process 600 for fabricating a HAMR medium that includes a lubricant in accordance with an aspect of the disclosure. In one aspect, the process 600 can be used to fabricate the HAMR media described above, including medium 200 shown in FIG. 2.

At block 602, the process provides a substrate (e.g., substrate 202). At block 604, the process provides an optional adhesion layer (e.g., adhesion layer 204) on the substrate. At block 606, the process provides a heat sink layer (e.g., heat sink layer 206) on the adhesion layer. In one aspect, at block 608, the process may additionally provide an interlayer/seed layer (e.g., interlayer 208) on the heat sink layer. At block 610, the process provides a magnetic recording layer (MRL) (e.g., MRL 210) on the interlayer/seed layer. At block 612, the process provides a capping layer (e.g., capping layer 212) on the MRL.

At block 614, the process provides an overcoat layer (e.g., overcoat layer 214) on the capping layer. At block 616, the process provides a lubricant layer, e.g., lubricant layer 216, on the overcoat layer.

It is important to note that in alternative approaches, the lubricant layer formed above the protective overcoat may include any of the multidentate fluoroalkyl, fluoroalkenyl, perfluoroalkyl, or perfluoropolyether boundary lubricants described herein, singly and/or in any combination.

In various aspects, the lubricant layer can be formed on the magnetic recording medium, specifically on the protective overcoat, via a dip coating method. For instance, in one aspect the magnetic recording medium may be dipped into a lubricant bath including the multidentate perfluoropolyether boundary lubricant according to one or more aspects of the disclosure and a fluorocarbon solvent such as HFE7100 (hydrofluoroether) or VERTREL-XF (hydrofluorocarbon). After a predetermined amount of time, the magnetic recording medium may be pulled out from the lubricant bath at a controlled rate. The solvent may then evaporate, leaving behind a lubricant layer including the multidentate perfluoropolyether boundary lubricant. The bonding percentage is quantified by stripping the lubricated magnetic recording medium with the solvents used in the lubricant bath at various post-lube time periods.

The thickness of the lubricant layer may be tuned by controlling the submergence duration of the magnetic recording medium in the lubricant bath, the rate at which the magnetic recording medium is removed from the coating solution, and/or the concentration of the boundary lubricant (e.g. the lubricant according to one or more aspects of the disclosure) in the lubricant bath.

In one or more aspects, the concentration of lubricant in the lubricant bath may be in a range from about 0.001 grams per liter (g/L) to about 1 g/L. In yet other aspects, the concentration of the lubricant in the lubricant bath may be selected so as to achieve a resulting lubricant layer with a thickness in a range from about less than or equal to about 10 nanometers (nm), or less than or equal to about 5 nm, or less than or equal to about 1 nm or from 0.1 nm to less than about 1 nm.

Likewise, the formation of the lubricant layer on the surface of the magnetic recording medium, specifically on the surface of the protective overcoat, is not limited to dip coating, but may also involve spin coating, spray coating, a vapor deposition, combinations thereof, or any other suitable coating process as would be understood by one having skill in the art upon reading the present disclosure.

### Burnishing

Burnishing is a manufacturing process for HDD to reduce asperities and the disk surface. If the lubricant film thickness exceeds its monolayer thickness, the extra lubricant is readily removed by burnishing. On the contrary, when the lubricant film thickness is below the monolayer thickness, the lubricant remains undisturbed. Thus, the monolayer film thickness could be determined by burnishing the disk surface as a function of film thickness. The changes in the lubricant film thickness before and after burnish provide an estimate for the monolayer thickness.

Several different burnishing pad designs are commonly utilized. Some heads have a burnishing ridge providing a burnishing edge that extends across the entire front surface of the head. Other current head designs have burnishing members on the left side and right side of the burnishing head, but have a lengthwise channel between the left and right burnishing members. In such heads, a significant portion of the burnishing head does not burnish the disk, resulting in significant inefficiency in the burnishing process. In one configuration, the burnishing pad has a waffle type pattern of burnishing pads; that is, a plurality of diamond shaped burnishing pads that are disposed on the burnishing head surface. The diamond shaped pads are oriented such that the point of each diamond shaped pad is directed towards the media to be burnished.

### Thermal Annealing

The thermal annealing of the lubricants of the disclosure, resulting in advanced adhesion of the lubricant to the COC, is related to the thermal degradation of polymers. In polymers, such as plastics or the lubricants of the disclosure, thermal degradation refers to a type of degradation where chemical changes take place at elevated temperatures, without the simultaneous involvement of other compounds such as oxygen. Even in the absence of air, polymers will begin to degrade if heated high enough. It is distinct from thermal-oxidation, which can usually take place at less elevated temperatures.

The onset of thermal degradation dictates the maximum temperature at which a polymer or lubricant can be used. It is a limitation in how the polymer is manufactured and processed. For instance, polymers become less viscous at higher temperatures, but thermal degradation places a ceiling temperature on this. Polymer or lubricant devolatilization is similarly affected. At high temperatures, the components of the long chain backbone of the polymer or lubricant can break (chain scission) and react with one another (cross-link) or react to the substrate to change the properties of the polymer. These reactions result in changes to the molecular weight (and molecular weight distribution) of the polymer and can affect its properties.

### Optical Annealing

Optical annealing of the lubricants of the disclosure is related to the photo-oxidation of polymers. In polymer chemistry, photo-oxidation (sometimes: oxidative photodegradation) is the degradation of a polymer surface due to the combined action of light and oxygen. It is the most significant factor in the weathering of plastics. Photo-oxidation causes the polymer chains to break (chain scission), resulting in the material becoming increasingly brittle. This leads to mechanical failure and, at an advanced stage, the formation of microplastics. In textiles the process is called phototendering.

Susceptibility to photo-oxidation varies depending on the chemical structure of the polymer. Some materials have excellent stability, such as fluoropolymers, polyimides, silicones and certain acrylate polymers. The strained anchoring functional group of the lubricant of the disclosure addresses the high stability of the fluoropolymer backbone, by being susceptible to light to break the strained functional group (which can be a strained ring such as cyclopropane or cyclobutane) and thus react with the surface of the COC layer to create an enhanced bond between the lubricant and the underlying disk. The types of light used for optical annealing can typically include laser light. Ultraviolet radiation for lasers includes wavelengths between 180 and 400 nanometers (nm). The visible region is radiation with wavelengths between 400 and 700 nm. The infrared region of the spectrum is radiation with wavelengths between 700 nm and 1 mm. The lubricant of the disclosure does not necessarily require a laser to supply light. Ultraviolet or infrared lamps can be used instead.

It should be noted that methodology presented herein for at least some of the various aspects may be implemented, in whole or in part, in computer hardware, by hand, using specialty equipment, etc. and combinations thereof.

Moreover, any of the structures and/or steps may be implemented using known materials and/or techniques, as would become apparent to one skilled in the art upon reading the present disclosure.

In some aspects, for the processes described herein, the processes herein can perform the sequence of actions discussed above in a different order. In other aspects, the processes can skip one or more of the actions. In still other aspects, one or more of the actions are performed simultaneously. In some aspects, additional actions can be performed. For example, in one aspect, the process may include any additional actions needed to fabricate the magnetic recording layer structure.

In some aspects, the forming or deposition of such layers can be performed using a variety of deposition sub-processes, including, but not limited to physical vapor deposition (PVD), direct current (DC) sputter deposition, ion beam deposition, radio frequency sputter deposition, or chemical vapor deposition (CVD), including plasma enhanced chemical vapor deposition (PECVD), low pressure chemical vapor deposition (LPCVD) and atomic layer chemical vapor deposition (ALCVD). In other embodiments, other suitable deposition techniques known in the art may also be used.

The terms “on,” “above,” “below,” and “between” as used herein refer to a relative position of one layer with respect to other layers. As such, one layer deposited or disposed on/above or below another layer may be directly in contact with the other layer or may have one or more intervening layers. Moreover, one layer deposited or disposed between layers may be directly in contact with the layers or may have one or more intervening layers.

The above description is made for the purpose of illustrating the general principles of the present disclosure and is not meant to limit the inventive concepts claimed herein. Further, particular features described herein can be used in combination with other described features in each of the various possible combinations and permutations.

It should be noted that in the development of any such actual aspect, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the device, system and/or method used/disclosed herein can also be formed from some components other than those cited.

Unless otherwise specifically defined herein, all terms are to be given their broadest possible interpretation including meanings implied from the specification as well as meanings understood by those skilled in the art and/or as defined in dictionaries, treatises, and the like.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 20 angstroms (Å) refers to a thickness of 20 Å+/−2 Å, e.g., from 18 Å to 22 Å in this example.

In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.” The term “and/or” refers to both the inclusive “and” case and the exclusive “or” case, and such term is used herein for brevity. For example, a composition including “A and/or B” may include A alone, B alone, or both A and B.

Various components described in this specification may be described as “including” or made of certain materials or compositions of materials. In one aspect, this can mean that the component is made of the particular material(s). In another aspect, this can mean that the component includes the particular material(s). In another aspect, this can mean that the component is formed from only the particular material(s) (e.g., “consists of” only the particular material(s)). In another aspect, this can mean that the component is formed primarily from the particular material(s) (e.g., “consists essentially of” the particular material(s)), with a percentage of those materials at 75%, 80%, 85%, 90%, or 95%.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. It is further noted that the term “over” as used in the present application in the context of one component located over another component, may be used to mean a component that is directly on another component and/or in another component (e.g., directly on a surface of a component or embedded in a component). Thus, for example, a first component that is over the second component may mean that (1) the first component is over the second component, but not directly touching the second component, (2) the first component is directly on (e.g., directly on a surface of) the second component, and/or (3) the first component is in (e.g., embedded in) the second component. The term “about ‘value X’”, or “approximately value X,” as used in the disclosure shall mean within 10 percent of the ‘value X’. For example, a value of about 1 or approximately 1 would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range. In the disclosure various values (e.g., value X) may be specified, described and/or claimed. In one embodiment, it should be understood that the value X may be exactly equal to X. In one embodiment, it should be understood that the value X may be “about X,” with the meaning noted above.

While various aspects have been described above, it should be understood that they have been presented by way of example only, and not limitation. Thus, the breadth and scope of an aspect of the present invention should not be limited by any of the above-described exemplary aspects, but should be defined only in accordance with the following claims and their equivalents.

1. A lubricant comprising:
a plurality of segments according to general formula (I): 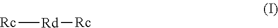
where Rd is a linker and each Rc is a reactive end-group containing at least one constituent configured for at least one of tribochemical, thermochemical, or optochemical bonding.

2. The lubricant of claim 1, wherein the at least one constituent configured for at least one of tribochemical, thermochemical or optochemical bonding is a strained ring.

3. The lubricant of claim 1, wherein the at least one constituent configured for at least one of tribochemical, thermochemical, or optochemical bonding is a ring having a strain energy greater than 10 kilocalories per mole (kcal/mole).

4. The lubricant of claim 1, wherein the at least one constituent configured for at least one of tribochemical, thermochemical, or optochemical bonding is a ring having a strain energy greater than 20 kcal/mole.

5. The lubricant of claim 1, wherein the at least one constituent configured for at least one of tribochemical, thermochemical, or optochemical bonding is selected from the group consisting of cyclopropane, cyclobutane, cyclononane, cycloundecane, norbornene, bicyclo[1.1.0]butane, bicyclo[1.2.0]pentane, bicyclo[1.3.0]hexane, borirane, aziridine, oxirane, phosphirne and thiirane.

6. The lubricant of claim 1, wherein the at least one constituent configured at least one of tribochemical, thermochemical, or optochemical bonding is a C₃-C₁₆ hydrocarbon ring.

7. The lubricant of claim 1, wherein the at least one constituent configured for at least one of tribochemical, thermochemical, or optochemical bonding is cyclopropane or cyclobutane.

8. The lubricant of claim 1, wherein the at least one constituent configured for thermochemical bonding is selected from the group consisting of acetonitrile, propionitrile, acrylonitrile, cyanoacrylate, benzonitrile, butyronitrile, cyanoacetic acid, isobutyronitrile, lactonitrile, methyl isocyanate, propyl isocyanate, butyl isocyanate, toluene diisocyanate, hexamethylene diisocyanate and methylene diphenylmethane diisocyanate.

9. The lubricant of claim 1, wherein the at least one constituent configured for optochemical bonding is selected from the group consisting of acrylates, methacrylates and o-nitribenzyl.

10. The lubricant of claim 1, wherein Rd includes at least one anchoring functional group comprising at least one of a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, a saturated, unsaturated, aromatic, polycyclic aromatic, heteroaromatic, alicyclic, or heterocyclic C₁-C₅₀ radical.

11. The lubricant of claim 1, wherein Rd includes at least one anchoring functional group comprising —OH.

12. The lubricant of claim 1, wherein Rc includes at least one anchoring functional group comprising at least one of a B, Si, pnictogen, chalcogen, or halogen, —OR*, —NR*₂, —NR*—CO—R*, —OR*, —O—CO—R*, —CO—O—R*, —SeR*, —TeR*, —PR*₂, —PO—(OR*)₂, —O—PO—(OR*)₂, —N═P(NR*₂)₃, —AsR*₂, —SR*, —SO₂—(OR*)₂, —BR*₂, —SiR*₃, —(CH₂)_{q}—SiR*₃, —(CF₂)_{q}—SiR*₃, or a combination thereof, wherein q is 1 to 10 and each R* is, independently a hydrogen, a pnictogen/chalcogen/halogen, a saturated, unsaturated, aromatic, polycyclic aromatic, heteroaromatic, alicyclic, or heterocyclic C₁-C₅₀ radical.

13. The lubricant of claim 1, wherein Rc includes at least one anchoring functional group comprising —OH.

14. The lubricant of claim 1, wherein the tribochemical, thermochemical or optochemical bonding comprises bonding with a carbon overcoat layer of a magnetic recording medium.

15. A magnetic recording medium, comprising:
a magnetic recording layer on a substrate;
a protective overcoat on the magnetic recording layer; and
a lubricant layer comprising the lubricant according to claim 1 on the protective overcoat.

16. A data storage system, comprising:
at least one magnetic head;
a magnetic recording medium including the lubricant of claim 1;
a drive mechanism for positioning the at least one magnetic head over the magnetic recording medium; and
a controller electrically coupled to the at least one magnetic head for controlling operation of the at least one magnetic head.

17. A method of bonding a lubricant to a carbon overcoat layer (COC) of a magnetic recording medium, including:
coating the lubricant of claim 1 on the COC; and
applying at least one of mechanical action, heat or light to the lubricant to bond the lubricant to the COC.

18. The method of claim 17, further comprising:
burnishing the magnetic recording medium.

19. A method of synthesizing the lubricant of claim 1, comprising: 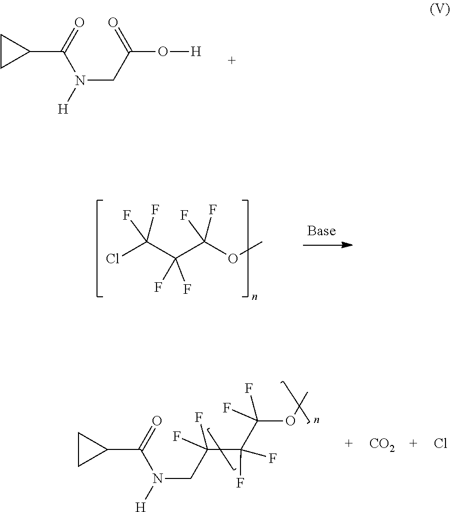
where n=10-200 and the at least one constituent configured for at least one of tribochemical, thermochemical, or optochemical bonding is cyclopropane.

20. A method of synthesizing the lubricant of claim 1, comprising: 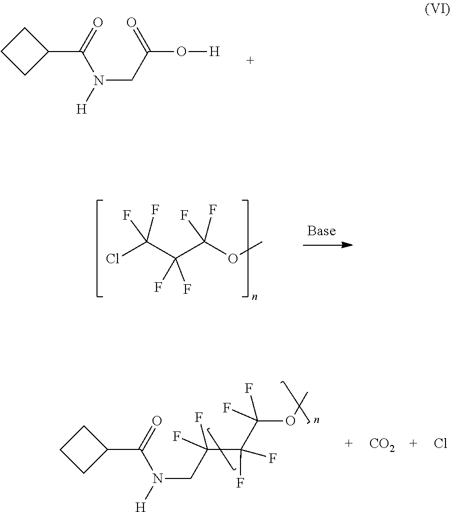
where n=10-200 and the at least one constituent configured for at least one of tribochemical, thermochemical, or optochemical bonding is cyclobutane.
